(19) United States
(12) Patent Application Publication
(10) Pub. No.: US 2015/0031434 A1
(43) Pub. Date: Jan. 29, 2015

(54) Method and System for Enhancing Lottery Gaming Payout Perceptions with Coupons

(71) Applicant: Scientific Games International, Inc., Newark, DE (US)

(72) Inventors: Edward J. Stanek, Des Moines, IA (US); John C. Schreurs, Des Moines, IA (US); Michael R. Schreurs, Johnston, IA (US)

(73) Assignee: Scientific Games International, Inc., Newark, DE (US)

(21) Appl. No.: 13/950,843

(22) Filed: Jul. 25, 2013

(51) Int. Cl. G07F 17/32

(52) U.S. Cl. CPC G07F 17/329
USPC 463/17

(57) ABSTRACT

A method for enhancing ticket-based lottery games with coupons includes defining a coupon inventory of available coupons from third party sponsors. An initial coupon matrix is generated wherein a controlled number and value of coupons are assigned to a ticket-based lottery game or games. The coupon matrix is determined as a function of availability of particular coupons over a defined time period and specified third party sponsor redemption liability. Access codes are provide on lottery tickets generated for the ticket-based lottery game, wherein players are able to use the coupon access code to identify and redeem a coupon associated with the coupon access code from the coupon inventory.

### FIELD OF THE INVENTION

The subject matter of the present invention relates generally to a method for distribution of lottery tickets, and more particularly to a method for enhancing the perceived value of lottery tickets through a system of interactive, strategic allotment and distribution of coupons using codes printed on the lottery tickets that result in the digital distribution of coupons based on associated lottery ticket and coupon affinity and management information.

### BACKGROUND

In designing lottery games, particular attention must be paid to mathematically relating sales of lottery products (e.g., lottery tickets) to frequency and magnitude of prizes such that the sum of all prizes plus expenses for producing, distributing, and retailing lottery products does not exceed the income from sales. Profits come from minimizing these expenses and maximizing sales. Higher payouts to players, better odds of winning prizes, and desirability of prizes offered are important enticements to players and play a significant role in the sale of lottery products. However, given the expenses of administering a lottery game, there is a practical limit to the value of prizes that can be offered while still maintaining profitability.

For instance if profits account for 25% of sales, deferring an additional 5% of sales to enhance prizes as an incentive for players to purchase more tickets results in a 20% depletion of per ticket profits. Therefore, overall sales must improve by at least 20% in order to maintain former profits or the deferral is a meaningless exercise from the lottery's net revenue point of view.

In addition to prizes, entertainment is delivered to players as a motivation for purchasing gaming products. In optimizing value delivered to the consumer as a stimulus for more sales, there exists another opportunity to enhance value on lottery products beyond prize paybacks and entertainment. That value may come in the form of coupons associated with lottery tickets sponsored by manufacturers, retailers, or promoters, who offer free or discounted merchandise or services (that may or may not involve gaming) to lottery players in a manner that does not require enhanced payouts and declining profit margins.

In normal (e.g., non-lottery related) coupon distribution, an allotment of discounts linked to consumer choices is made by a coupon sponsor. A medium such as newspapers, magazines, direct mail, or the Internet is used to distribute the coupons, with the price of a given newspaper, magazine, mailing, or Internet distribution cost being a set amount. Coupons are uniformly distributed based on criteria established by the coupon sponsor, such as geographic location of the targeted consumer. The media (e.g., newspaper or magazine) is also uniform in content—every purchaser of the same edition receives the same content.

If the medium for coupon distribution is printed lottery tickets, a similar distribution mechanism results in coupons of a specific value aligned with a given lottery game. But an array of state lottery games can vary in price and theme mix, which commonly change over time (in contrast to newspapers and magazines that are generally uniformly priced media, and mailings that have set prices based on bulk delivery costs).

It would be highly desirable in the art to proactively align a spectrum of coupon values to be weighted and distributed on lottery tickets in concert with the marketing strategy for lottery games.

### SUMMARY

Objectives and advantages of the invention will be set forth in the following description, or may be obvious from the description, or may be learned through practice of the invention. It is intended that the invention include modifications and variations to the system and method embodiments described herein.

The present disclosure provides a method for enhancing ticket-based lottery games with coupons, which will increase the players' payout perceptions for the game. The method includes defining a coupon inventory of available coupons from third party sponsors. An initial coupon matrix is generated wherein a controlled number and value of coupons are assigned to a ticket-based lottery game or games, with the coupon matrix determined as a function of availability of particular coupons over a defined time period and specified third party sponsor redemption liability. The method includes providing coupon access codes on lottery tickets generated for the ticket-based lottery game, wherein players are able to use the coupon access code to identify and redeem a coupon associated with the coupon access code from the coupon inventory.

In a particular embodiment, the value or particular third party sponsor of the associated coupon is not made known to the player until the player enters the coupon access code into a coupon management system via, for example, an Internet web site.

In certain embodiments, the player may be presented with a plurality of different coupon selections from available coupons within the coupon inventory, wherein coupons selected by players are then eliminated from the coupon inventory.

The inventory of coupons within the coupon matrix assigned to a particular lottery game may be dynamic in that it is continuously purged of expired coupons and updated with new coupons that become available from third party sponsors.

In other embodiments, the coupon matrix is varied subsequent to its initial generation while maintaining the controlled number and value of coupons assigned to the particular ticket-based lottery game or games.

The coupons associated with a particular coupon access code may, in certain embodiments, be randomly determined at the time of entry of the coupon access code by the player from the coupon inventory available at the time.

In certain embodiments, the coupon matrix may be generated such that one or more coupons associated with each respective access code has a redemption value that exceeds a purchase price of the lottery ticket to the player.

In some embodiments, the coupon matrix is generated subsequent to printing of the lottery tickets and prior to defining the coupon inventory.

The coupon matrix may be generated so that coupons offered on lottery tickets are for discounts on products or services offered by retailers that sell the lottery tickets. Similarly, in certain embodiments, the coupon matrix is generated so that coupons offered on lottery tickets are not for discounts on products or services offered by competitors to retailers that sell the lottery tickets.

The coupon matrix may be generated so that the redemption value of coupons associated with the coupon access codes is a function of a purchase price of the lottery ticket.

The coupon matrix may be generated so that coupons having a particular redemption value or value range are associated with the coupon access codes for non-winning lottery tickets. For example, the average redemption value of coupons for non-winning lottery tickets may be higher than for winning lottery tickets.

In certain embodiments, upon entry of the coupon access code, the player is presented with options to create coupons of their choosing so long as such coupons are within boundary parameters of the coupon matrix for the overall lottery game.

The coupon management system may be configured to maintain and update a coupon dashboard for viewing by the third party sponsors, wherein the dashboard displays information on player viewing or selection of the third party coupons within the coupon inventory. The management system may be interactive and the third party sponsors permitted to exchange particular coupons within the coupon inventory that fall within boundary parameters of the coupon matrix for the overall lottery game.

Additional aspects of particular embodiments of the invention will be discussed below with reference to the appended figures.

### BRIEF DESCRIPTION OF THE DRAWINGS

A full and enabling disclosure, including the best mode thereof, to one of ordinary skill in the art, is set forth more particularly in the remainder of the specification, including reference to the accompanying Figures, in which:

FIG. 1 is a table showing an example of a possible distribution of coupon values versus lottery ticket price. Other variables (such as retailer constraints and specific lottery ticket and coupon identifiers) go into the construction of the multidimensional coupon distribution matrix.

FIG. 2 is a table representing the possible distribution of coupons with value ranges across lottery ticket price points, wherein each entry could represent from a few million to over one billion tickets.

FIG. 3 shows an example of a scratch-off lottery ticket with a covering over the area containing the coupon access code.

FIG. 4 shows the ticket in FIG. 3 with the access code revealed. This portion of the ticket could also contain a scannable code to link via a mobile device to the coupon landing page and/or instructions on how to access the landing page from a laptop or desktop computer (or other Internet-enabled device).

FIG. 5 shows an example of a coupon landing page with a graphic of the lottery ticket. The coupon access code has been entered along with the optional email address of the lottery player and streaming of brands that sponsor coupons appears across the bottom. There is a button to submit the request to display the coupon offerings.

FIG. 6 shows three coupon offerings that include the brand available and the denomination of the coupon from which the player chooses by clicking on the choice. The number of coupon offerings can vary and a single offering might contain more than one coupon.

FIG. 7 shows an exemplary coupon as finally chosen on the Internet landing page.

FIG. 8 is a flow chart showing the lottery ticket/coupon pipeline, logic, and distribution system.

### DETAILED DESCRIPTION

Reference will now be made in detail to various embodiments of the presently disclosed subject matter, one or more examples of which are set forth below. Each embodiment is provided by way of explanation, not limitation, of the subject matter. In fact, it will be apparent to those skilled in the art that various modifications and variations may be made to the present disclosure without departing from the scope or spirit of the disclosure. For instance, features illustrated or described as part of one embodiment, may be used in another embodiment to yield a still further embodiment. Thus, it is intended that the present disclosure cover such modifications and variations as come within the scope of the appended claims and their equivalents.

Conventional coupons are printed in newspapers, printed as inserts to be distributed in newspaper deliveries, sent via direct mail, and available in stores on product offerings. Sometimes the coupons are good for free merchandise or services, and sometimes they provide a discount to a consumer for a current or future purchase. They can be used to induce trial of something new, to give a competitive edge, to sell merchandise in greater volume in new or key markets over specified times, or to reduce inventories or to time sales for strategic reasons. Give-aways or discounts can be limited through the production of limited quantities of coupons that may be secure instruments, or can be open-ended promotions for a time based on the liability that the sponsor wishes to budget or a result that the sponsor wishes to achieve, such as new product trial.

For these reasons, it is important that the printing of coupons be controlled in both time and liability—meaning protection from over-circulation, from untimely distribution, and in some cases from counterfeiting. The time-wise circulation of newspapers and magazines is a given. Newspaper editions are mostly daily, weekly, or monthly publications. Magazines are generally published monthly with specific distribution dates, and the content is the same within an edition. With these distribution sources, coupon introduction is relatively easy to control, albeit the coupons cannot be targeted beyond the general readership of the newspapers, magazines, and the like. Direct mail can target neighborhoods, but often targets street addresses or specific individuals.

Scratch-off lottery games are designed months in advance of their planned sales dates. Printed tickets are delivered to lotteries (e.g., state or jurisdictional lottery authorities) weeks or months in advance of their delivery to retailers. The tickets sell over a period of time that is difficult to predict because they may remain on sale until all the tickets in the game have been sold (a function of player enthusiasm for a particular game) or the lottery removes a particular ticket from sale for lack of consumer interest. Although the artwork on a given lottery game may be uniform from ticket to ticket, the main content (including the lottery play parameters) are computer imaged and change from ticket to ticket, making each ticket unique.

Magazines are unlikely to move up the delivery date of a March publication because its February edition sold well. If all the newspapers for a Thursday edition are sold, the Friday edition is not used to supplant the Thursday edition. However, lottery ticket games that sell-out are commonly supplanted by a succeeding game to retain market availability.

Coupons on lottery tickets can be targeted to the specific lottery demographic, but tickets are generally distributed among retailers somewhat at random and their sale depends on the popularity of a game and is limited to the quantity of tickets printed. If coupons are printed on lottery tickets in the same way that they are printed on other paper media, the game may sell out before a coupon promotion is finished or the game sales may lag and overstep the coupon expiration date set by the coupon sponsor. There may be more tickets printed for a game than a sponsor wishes to have coupons distributed. The secure nature of the printing of lottery tickets requires considerable expense that does not allow for compromising quantities of tickets primarily intended as a gaming mechanism rather than simple reading medium.

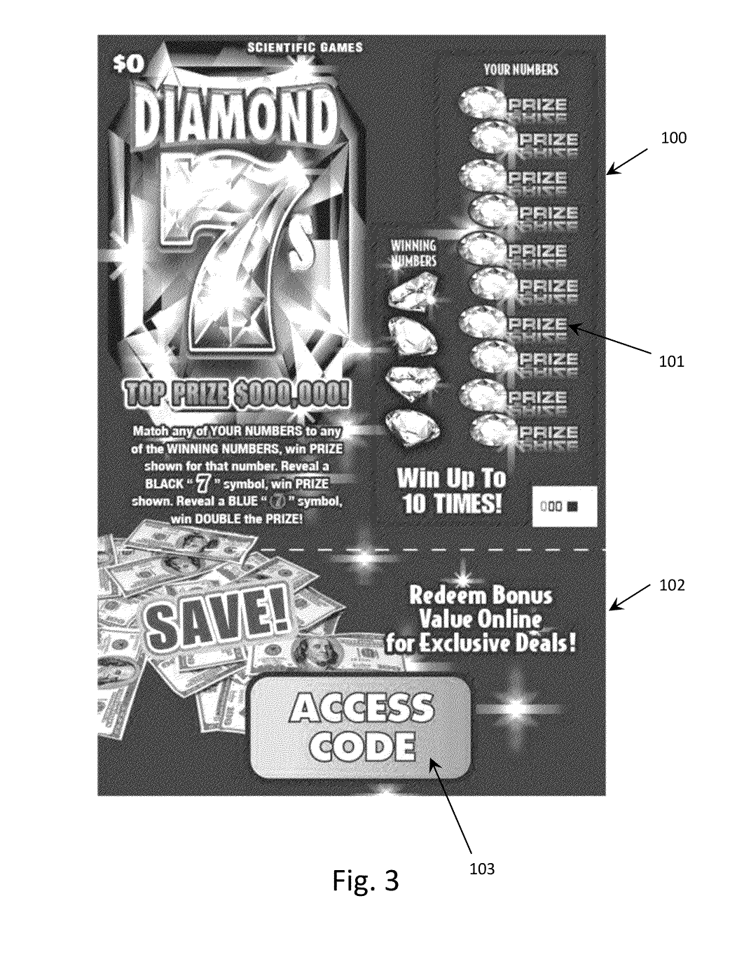

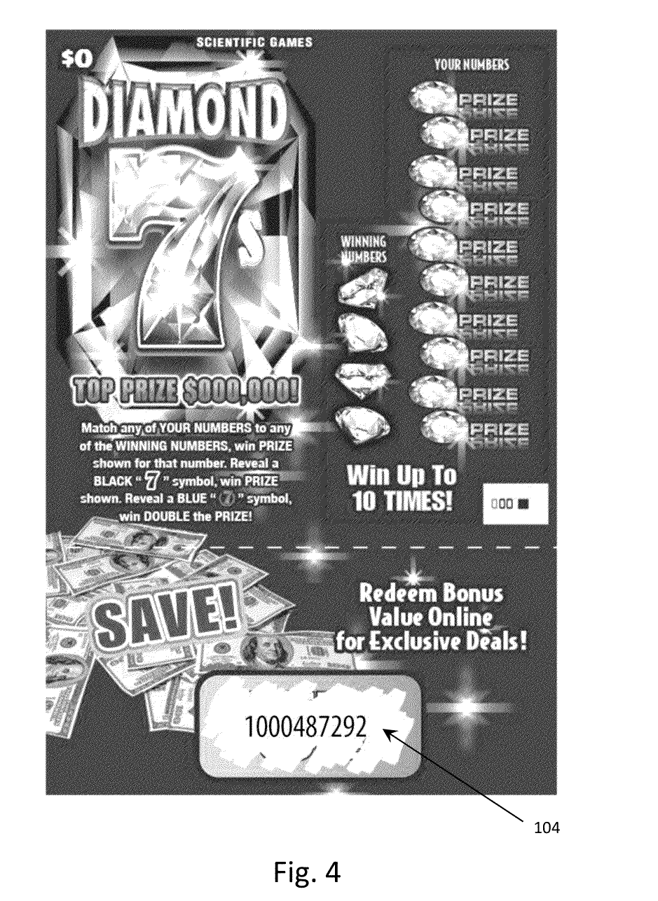

However, these obstacles can be overcome by utilizing digital communications and software specific to the lottery industry and the addition of new techniques. Coupons can be made unique to specific lottery tickets with an identifier assigned to the coupon in a similar manner that identifiers are assigned to lottery tickets themselves. The identifier can be covered with a scratch-off coating (SOC) just as on the gaming part of a lottery ticket (FIG. 3). The coupon can be made part of the lottery ticket with a perforated edge or edge intended for cutting so that it can be separated from the lottery ticket itself. By removing the SOC, the coupon code is revealed (FIG. 4). The code can also be printed by a lottery terminal or cash register for draw-type lottery games. The code is the link to a virtual coupon or coupons issued over a wide area network, such as the Internet, utilizing the lottery ticket's unique identifier or unique coupon identifier.

Sponsors are enlisted to subscribe to coupon distribution according to the offers they wish to promote in terms of quantities, values, and the timing of introduction and expiration. They are queued with other sponsors of other products or services such that a master file is prepared. The general contents of the file may be advertised, but the coupon value and product applicability is hidden from the consumer until after a lottery ticket is purchased. Once the coating on the coupon portion of a lottery ticket is removed (or printed on demand in the case of draw games sold at retailers), the consumer is directed to a web site where the coupon identifier is entered. Thereupon the value of the coupon or coupons and products for which it/they are intended are revealed—or a range of couponed products, services and values may be displayed on the consumer's Internet-enabled device for the consumer to choose from.

A large range of values can be programmed for the coupons, e.g., from delivering 50 cents off on a tube of toothpaste, a free hamburger, $100 off on an airline flight, a half price weekend at a hotel or casino, even to a $1,000 discount on a new automobile. The player may be presented with a choice among a limited number the offerings.

A “digital” pipeline is created such that the lottery/coupon administrator can control the flow of promotions put into one end of the circulation/distribution pipeline and may alter their flow through discrete digital decisions (i.e., “digital gates”) before display over the Internet or other communication to the consumer. Hence, the expired promotions can be electronically purged while new ones are digitally inserted at the pipeline's beginning or elsewhere along the pipeline.

Since the lottery tickets are generally purchased at retailers (although this is not a limitation of the invention), special emphasis can be applied so as not to channel promotions that feature competing retailers or conversely can insure that revealed promotions channel the consumer back to the lottery retailer who sold the lottery ticket to promote discounts at that specific retailer, or even can be confined to products sold at that retailer.

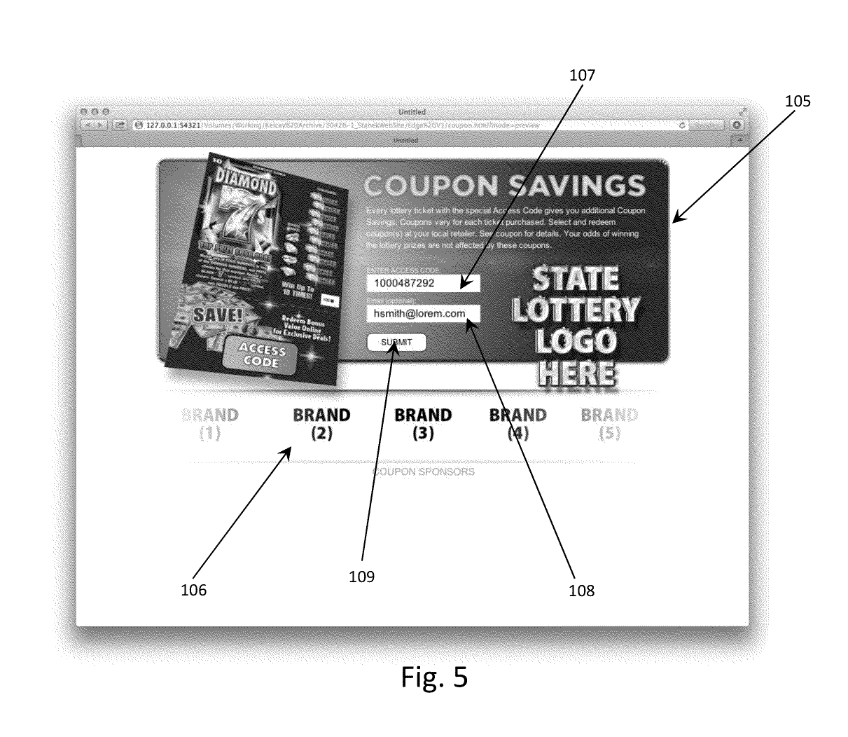

The flexibility of the present system makes possible the entire management of volume of coupons, the timing of promotions, and their expiration dates to be coincident with sponsor wishes after the tickets and coupons have in fact been printed (or downloaded in the case of electronic instant tickets) and even sold, but before the identifier displayed on the ticket or coupon (e.g., under the SOC) has been registered on an Internet landing page (FIG. 5).

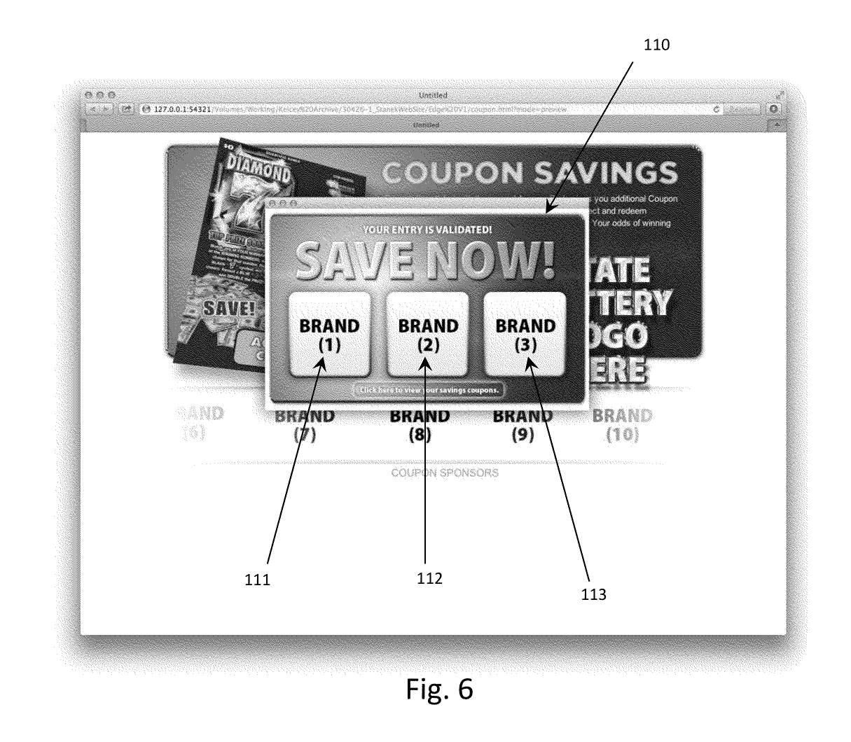

In a particular embodiment, an array of coupon offerings can be made with a given registration whereby the lottery player is given the choice of several coupon packages (FIG. 6).

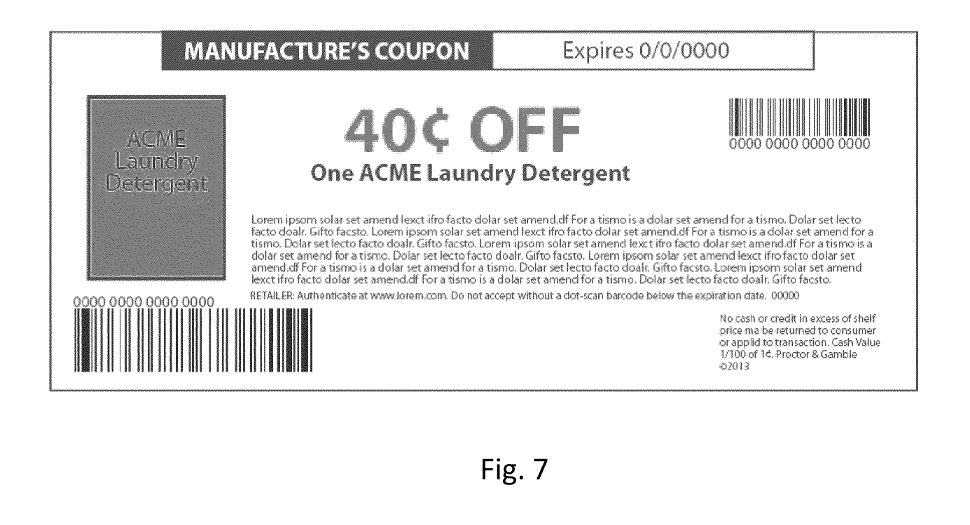

The coupon itself can be redeemed and surrendered, the lottery ticket can be redeemed and surrendered, or a barcode or QR code or other identifier can be printed using a printer or sent to a mobile device for display on a screen to redeem the coupon (FIG. 7). The system can cancel or digitally mark the redemption so that the identifier on the coupon cannot be redeemed a second time.

Thus, value can be sold to sponsors of merchandise and services to obtain a premium from the sponsors for printing the coupons on lottery tickets. The process may also net higher revenues for such printing or licensing from state lotteries (or other eligible entities) if the coupon laden tickets sell better than non-coupon laden tickets; and consumers are happier because there is value to be had on lottery tickets even if they don't win a lottery prize. Although the coupon is a not a prize itself, the tickets bearing coupons have more monetary value as compared to non-coupon tickets and thus become more “prized” and may be perceived as a bonus. The mystery involved in the coupon nature and value adds additionally to the entertainment or play value of the ticket.

Although lottery prizes are taxed as income at the federal level and at most state levels as income, discounts and distributions of free merchandise and services available on coupons are not. Hence the search for high value coupons on lottery tickets where the value is not a prize and not taxed as income becomes an additional incentive to buy more lottery tickets.

In addition, merchandise that is discounted or given away free as a result of a coupon requires paying sales tax only on the tender conveyed from the coupon redeemer to the retailer. Thus, the sales tax is also effectively reduced by the ratio of the value of the coupon to the otherwise total price of the merchandise or service.

When coupons appear in newspapers, there is consideration given for the newspaper as a prerequisite to obtaining the coupon even though the coupon itself is not purchased—the price of the newspaper is the same with or without the coupons. The same principle in this scenario applies to the lottery tickets except that the value of the coupon is not known until the SOC is removed (or code is printed in the case of on-demand draw game ticketing) and the identifier registered with the system administrator on an Internet landing page (FIG. 5). Thus, the coupons may deliver the emotional sensations that accompany winning a prize without being funded by a lottery prize pool. The perceived monetary value associated with the lottery tickets in a particular game can be greater than the prize pool reserved for the game or even the sum of the payments for the tickets while enhancing rather than devaluing profitability.

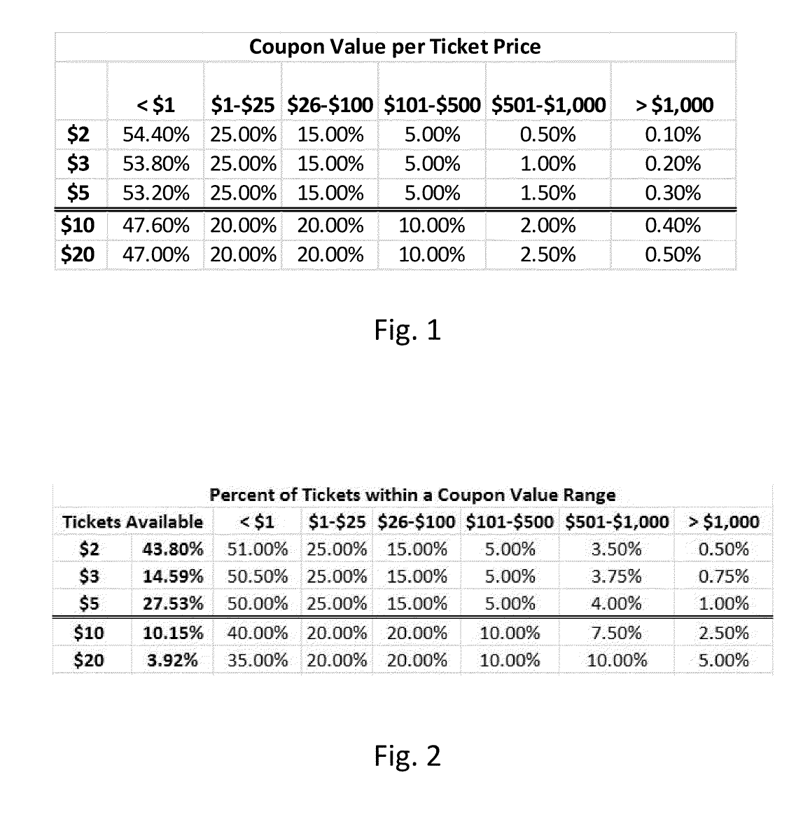

Coupon promotions can be tailored in value to align with the price point of the lottery ticket sold (i.e., higher incidence of greater value promotions on more expensive tickets) or can be tailored to the price point demographic identified as most attracted to bargains (e.g., household products are promoted on lower price point tickets and luxury products are promoted on higher price point tickets). To add entertainment value to the coupon by unveiling and discovery by the lottery player, a “matrix” can be computer generated so that a spectrum of coupon values is assigned across a game or across a number of games such that there is a controlled distribution of coupon denominations and subjects. The matrix is created to adhere to conditions established by the availability of coupons at any time (See the table in FIG. 1) and translated into the number of tickets that will be printed to determine exposure for redemption liability (See the table in FIG. 2). The matrix then assigns the specific coupons available to specific lottery tickets within the matrix.

Although coupons can be prizes and funded from the lottery game prize pool, they may also be assigned to lottery tickets without funding from the prize pool and devoid of revenues collected from lottery players. They can be sponsored by third parties, such as advertising agencies, manufacturers, service providers, and retailers that have nothing to do with the lottery except that their promotions use the lottery ticket as a medium for delivery.

Third party sponsors can contract with the lottery ticket printer or the printer's agent for a specific promotion involving coupons. The liability is set by specifying the number and denominations of coupons and the details of a specific offering. The beginning and ending time frames for the promotion may also be specified. The ticket printer through a coupon administrator then aggregates the coupon offerings subscribed and uses software to determine the number and types of coupons to be offered in association with a lottery game or games. The aggregation can be tailored so that it meets all of the subscribers' or sponsors' specifications but also can assign a distribution of coupon values or subject matter across a lottery game or games such that the discovery of coupon values is also an amusement. For instance, the matrix can be created such that certain value coupons are only made available on non-winning tickets. The matrix could provide that higher average coupon values are assigned to higher price point lottery games or that the preponderance of lower value coupons are assigned to lower price point lottery games.

For example, 10% of the coupons assigned to a $2 price point game could aggregate to $10 per ticket, while 80% of the coupons could aggregate to $2 or less, while still other coupon values and distribution percentages could be assigned to values in between $2 and $10 or even for coupons in excess of $10 in value. The mix may be altered after a lottery game goes on sale so as to optimize lottery sales or manage the ever changing conglomeration of coupon offerings.

Another example distribution could make 10% of the coupons in a $20 game good for $100 or more in travel, entertainment or product discounts while making only 50% of the coupons good for $5 or less. The coupon offerings could be configured such that the coupon value for every ticket in an entire lottery game exceeds the purchase price of a ticket.

The distribution of coupons can be controlled within a given game or across a chosen multitude of games with the same or varying price points.

Since the nature of the coupons and values are not known by the lottery player until after the access code is revealed and entered via an Internet-enabled device in the lottery sponsored or maintained web site, the player anticipation is similar to that in playing the lottery game itself. Lottery game prizes in terms of payout percentage and size of the top prizes are generally more generous as the ticket price point increases.

With the method described above, a similar coupon distribution could be constrained as to numbers and values and then distributed randomly across their associated tickets or distributed with other criteria since the coupons are not prizes but rather promotions provided at no cost to the lottery player.

Although described herein with respect to paper or substrate tickets for sake of illustration only, it should be appreciated that the present invention is not limited to physical paper or substrate tickets. The invention includes implementation of the coupon enhancements with any manner of electronic or virtual tickets as well, such as Internet-based electronic lottery tickets that are distributed and played in electronic form.

A sample matrix appears in FIG. 1 based only on coupon discount value and lottery ticket price points for an array of games valued at $2 to $20.

Typical lottery games involve hundreds of thousands to many millions of tickets so a computer mechanism is necessary for the generation of the matrix and assignment of specific coupon offerings and values to conform to sponsor designations and a lottery ticket distribution strategy. The matrix may be made so that it can assign coupons at random from a predetermined array or to coordinate with the coupon codes printed on the lottery tickets and managed depending on retailer location, type of retailer (e.g., grocery or convenience store), or retailer product offerings.

The matrix can be managed by coordinating the known data regarding the retailer that sold a given lottery ticket such that the coupons generated from the coupon code associated with that specific ticket do not offer discounts on products carried only by that lottery retailer's competitors or conversely weight the offering of discounts on products sold toward products offered by that lottery retailer. The matrix can be programmed to offer coupons for private brands or products exclusively offered on the lottery tickets by a particular retailer. It should be remembered that with the exception of US lotteries themselves, almost all US lottery retailers are required to be principally in the business of selling non-lottery products.

FIG. 1 shows a hypothetical distribution of coupon values based only on the price point of their associated lottery tickets. This information is used to construct a multi-dimensional (many independent variables) matrix that also has dimensions for variables such as a lottery ticket identifier, specific coupon offering, sponsors' imposed expiration dates of coupons, brand constraints required so as not to cause retailer conflicts with coupons that could only be redeemed at retail competitors, specific tailoring to retailer constraints to channel traffic back to the lottery retailer outlet, and other constraints necessary to manage the coupon distribution system.

It should be remembered that unlike newspapers and magazines as coupon media, each lottery ticket is a secure instrument with identifiers that distinguish it uniquely from every other lottery ticket. Lottery tickets are tracked from the time they are printed, through distribution to a state lottery, and ultimately to a designated retail outlet. The tickets are then sold anonymously to lottery players who uncover the play areas (in the case of tickets with a SOC layer) to immediately discover what they have won in the case of scratch-type tickets or to wait for a drawing in the case of draw game tickets. In the case of scratch-type tickets, great pains are taken to fully protect the identification of prizes on the tickets until after the scratch-off coating has been removed since the prizes were determined at the time of printing and are apparent from information printed on the ticket. Security features are present to detect attempted alterations to the ticket, and the tickets are invalid if such fraudulent attempts are detected.

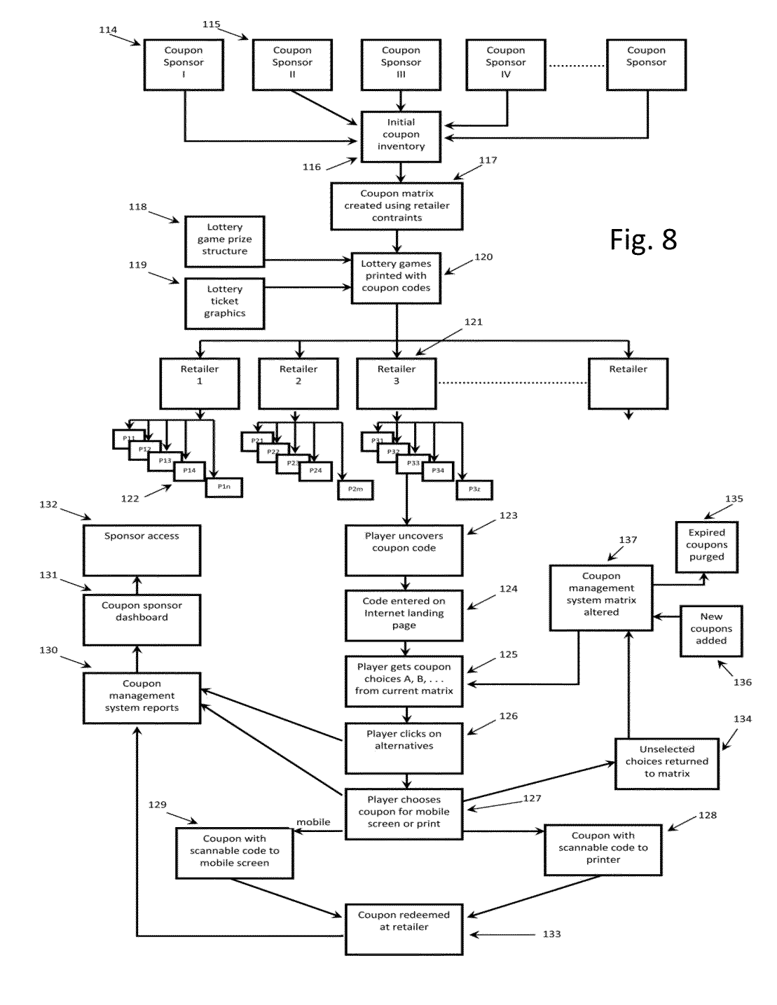

Although coupons might be programmed in a similar fashion for random distribution when printed on lottery tickets, this disclosure provides for a specific coupon management system that can be independent of the lottery prize structure to designate specific coupons to specific lottery tickets utilizing the ticket identifiers in the absence of lottery prize information. For scratch-type tickets, the coupon identifier is imaged on the lottery ticket at the time the ticket is printed. However, the coupon designation for that identifier may be changed by the coupon management system 137 (FIG. 8) at any time prior to a coupon/coupons being claimed on the Internet by the lottery player. In this case, the player has not paid extra for the coupon and the coupon is not part of the lottery prize structure.

Referring to FIG. 8, an array of third party coupon sponsors 114, 115 with varying product and/or service offerings are contracted for a specific number of coupons with specific discounts, for specific launch dates and specific expiration dates. This information is used to create the matrix with specific coupon designations to be blended with the game matrix for lottery tickets. In the case of draw games, the number of tickets sold for a particular drawing is undetermined until just before the drawing. Thus the coupon matrix 117 must be over-subscribed if it is desired to ensure that all draw game tickets have associated coupons. In the case of scratch-type tickets, the number of tickets is specifically determined at printing and the contracts with coupon sponsors determine the initial coupon distribution to be associated with preprinted coupon access codes creating the initial coupon inventory 116.

The initial coupon matrix 117 is combined with the lottery game prize matrix 118 and graphic requirements 119 to print the scratch tickets 120. The tickets are distributed to the retailers 121 that will sell the lottery game (usually in the thousands or tens of thousands for typical state lotteries). The tickets 100 are then sold to players 122 (usually hundreds of thousands to millions for typical state lotteries or even more for multi-state games).

The player scratches off the lottery game play area 101 (FIG. 3) to reveal winning or losing plays, and any prize that may be won. The ticket also contains the coupon area 102 and a covered coupon access code 103. The player scratches the area 103 (step 123 in FIG. 8) to reveal the coupon access code 104 (FIG. 4). For draw game tickets, the coupon access code may be printed on draw game tickets upon issuance of such tickets by a lottery terminal or other device.

The code 104 may be a scannable code such as a QR code or other printed link that directs the player at step 124 in FIG. 8 to an Internet landing page 105 (FIG. 5) or the player may be able to manually enter the code on the landing page at space 107 using any Internet-enabled device. The player may also be asked to enter his/her email address at space 108.

Brands or logos 106 may be displayed as advertising on the landing page. The player then submits the code entry (step 124 in FIG. 8) by clicking on the submit button 109 (FIG. 5).

The coupon management system 137 at this or an earlier stage has deleted expired coupons from the matrix (step 135 in FIG. 8) and updates the matrix with new coupons that have been added since the original matrix was created (step 136). The system 137 also administers the coupon offerings to limit them if desired to meet retailer needs such as offering a coupon for brand X cola instead of brand Y cola if the lottery retailer that sold the lottery ticket only sells brand X cola so that the customer (player) is not de facto channeled to a different retailer to redeem the coupon.

The management system 137 can also be programmed for local and/or temporary promotions specific to the retailer that sold the lottery ticket with the coupon code. In this way, the lottery retailer may become more enthusiastic to sell lottery tickets that market non-lottery products sold in his store or might become a coupon sponsor himself.

At step 125, the player receives a new page (FIG. 6) with coupon choices 110. The choices can be any number, but for illustration purposes only three choices 111, 112, 113 are shown in FIG. 6. The player clicks on each of interest and finally makes a selection that might be limited to fewer than all of those shown at step 126. The clicks are recorded and forwarded to the reporting section of the coupon management system at step 130 so that a charge can be made to the coupon sponsor for the clicks and can also be accessed on a dashboard at step 131 by the coupon sponsor to see where and when his coupons have drawn player interest at step 132.

The player then has the option at step 127 of having the chosen coupon/coupons printed on paper (step 128 with a code scannable by the coupon redeeming retailer) or sent as a code to a mobile device (step 129) to be displayed on a screen for similar reading by the retailer. In one embodiment, the lottery validation system software and hardware at the retailer may be adapted to read the codes and validate the coupon. In other embodiments, the normal coupon scanning equipment might be used. In still another embodiment, the credit/debit card system used by the retailer is adapted to validate the coupons. A computer application may be created to act as a coupon wallet so that several coupons can be redeemed by the player at once and automatically purge digitally saved coupons that have expired. In another embodiment, the player may instead of electing to receive a coupon himself, designate the coupon as a donation to a charitable organization that is programmed in the coupon management system as an allowed alternate receiver of the chosen coupon. In yet another embodiment, the coupon can be digitally designated through the coupon management system as a gift to another player who has an account or wallet set up for such use through a lottery players' club or similar program.

At step 127, the system also records and relays to the sponsor dashboard the printing of a coupon for accounting purposes and so that the sponsor can be charged appropriately while monitoring the successful issuance of a coupon to a willing lottery player.

At step 134, the unselected coupons are returned to the coupon management system 137 to be reinserted in the matrix to be offered on another lottery ticket and the selected coupons are purged from the coupon matrix.

At step 133, the coupon is redeemed and if desired once again the redemption is recorded and displayed on the sponsor dashboard.

Referring to FIG. 8, it should be appreciated that the coupon management system depicted therein may be implemented by various software and hardware configurations, which may include a group of lottery terminals at various retail establishments for sale and distribution of lottery tickets incorporating the coupon features described herein. The terminals are operatively coupled to a lottery or gaming authority network, which includes a lottery or gaming authority host computer server for carrying out any combination of the functions described herein, such as maintaining the landing page and other associated web pages for entry of the coupon codes, receiving player selection entries and maintaining/updating the coupon sponsor dashboard, deleting expired coupons from the system and updating the coupon inventory with added coupons, and so forth. Certain functionalities may be implemented by a computer system associated with the lottery ticket provider, such as generation of the initial coupon matrix. The lottery provider computer system may be interfaced with the lottery authority's coupon management system or the sponsor dashboard.

For carrying out the various lottery games with coupon enhancement functionalities described herein, a group or network of lottery terminal units may be operatively coupled to a lottery network computer or server via a network data link or bus. The lottery authority network may be coupled to a communication network, which may be, for example, the Internet, a wide area network (WAN), or a local area network (LAN) through a network hub or router via a first network link. In one possible configuration, the first network may be a state lottery system operating within an individual state or region of states. In this configuration, the individual lottery terminal units may be interconnected to a central system (e.g., host computer system with central lottery controller) for tracking and coordination of the state lottery system, including issued tickets, drawn numbers, and/or amounts wagered. In other embodiments, the network may be an internet or cellular based network.

The network layout of a given configuration may include personal devices such as home computers, smart phones, tablet devices, mobile devices, mobile device applications, etc., used to participate in the present disclosure.

The methods and game entries herein can be implemented in connection with any suitable hardware, software, firmware or combination thereof. In one embodiment, aspects of the coupon method and coupon code entries can be implemented by components of a client-side application, such as a smart phone, tablet computer, instant messaging application, mobile device application, or other client personal device; and, aspects of the method can be implemented by a server-side application such as a sever or network. It is to be understood that other applications can be utilized without departing from the spirit and scope of the claimed subject matter.

The material particularly shown and described above is not meant to be limiting, but instead serves to show and teach various exemplary implementations of the present subject matter. As set forth in the attached claims, the scope of the present invention includes both combinations and sub-combinations of various features discussed herein, along with such variations and modifications as would occur to a person of skill in the art.

What is claimed is:

1. A method for enhancing ticket-based lottery games with coupons, comprising:
defining a coupon inventory of available coupons from third party sponsors;
generating an initial coupon matrix wherein a controlled number and value of coupons are assigned to a ticket-based lottery game or games, the coupon matrix determined as a function of availability of particular coupons over a defined time period and specified third party sponsor redemption liability; and
providing coupon access codes on lottery tickets generated for the ticket-based lottery game, wherein players are able to use the coupon access code to identify and redeem a coupon associated with the coupon access code from the coupon inventory.

2. The method as in claim 1, wherein a value or particular third party sponsor of the associated coupon is not made known to the player until the player enters the coupon access code into a coupon management system.

3. The method as in claim 2, wherein the player enters the coupon access code into the coupon management system via an Internet web site.

4. The method as in claim 3, wherein the player is presented with a plurality of different coupon selections from available coupons within the coupon inventory, and coupons selected by players are subsequently eliminated from the coupon inventory.

5. The method as in claim 1, wherein the inventory of coupons within the coupon matrix assigned to the lottery game is dynamic and continuously purged of expired coupons and updated with new coupons that become available from third party sponsors.

6. The method as in claim 1, wherein the coupon matrix is varied subsequent to its initial generation while maintaining the controlled number and value of coupons assigned to the particular ticket-based lottery game or games.

7. The method as in claim 1, wherein the coupons associated with a particular coupon access code are randomly determined at the time of entry of the coupon access code by the player from the coupon inventory available at the time.

8. The method as in claim 1, wherein the coupon matrix is generated such that one or more coupons associated with each respective access code has a redemption value that exceeds a purchase price of the lottery ticket to the player.

9. The method as in claim 1, wherein the coupon matrix is generated subsequent to printing of the lottery tickets and prior to defining the coupon inventory.

10. The method as in claim 1, wherein the coupon matrix is generated so that coupons offered on lottery tickets are for discounts on products or services offered by retailers that sell the lottery tickets.

11. The method as in claim 1, wherein the coupon matrix is generated so that coupons offered on lottery tickets are not for discounts on products or services offered by competitors to retailers that sell the specific lottery tickets on which coupon codes are assigned.

12. The method as in claim 1, wherein the coupon matrix is generated so that the redemption value of coupons associated with the coupon access codes is a function of a purchase price of the lottery ticket.

13. The method as in claim 1, wherein the coupon matrix is generated so that coupons having a particular redemption value or value range is associated with the coupon access codes for non-winning lottery tickets.

14. The method as in claim 13, wherein an average redemption value of coupons for non-winning lottery tickets is higher than for winning lottery tickets.

15. The method as in claim 1, wherein upon entry of the coupon access code, the player is presented with options to create coupons of their choosing so long as such coupons are within boundary parameters of the coupon matrix for the overall lottery game.

16. The method as in claim 1, wherein the coupon management system maintains and updates a coupon dashboard for viewing by the third party sponsors, wherein the dashboard displays information on player viewing or selection of the third party coupons within the coupon inventory.

17. The method as in claim 16, wherein the dashboard is interactive and the third party sponsors are permitted to exchange particular coupons within the coupon inventory that fall within boundary parameters of the coupon matrix for the overall lottery game.

18. The method as in claim 1, wherein the coupon matrix is determined as a function of any combination of additional variables including a lottery ticket identifier, specific coupon offering, sponsors' imposed expiration dates of coupons, brand constraints required so as not to cause retailer conflicts with coupons that could only be redeemed at retail competitors, and specific tailoring to retailer constraints to channel traffic back to the lottery retailer outlet.

19. The method as in claim 1, wherein the coupon management system links with a digital wallet designated for a specific player to aggregate coupons for redemption at a particular retailer and purges expired coupons in the wallet.

20. The method as in claim 1, wherein the coupon management system digitally conveys chosen coupons from a player to a different player or a charitable organization as allowed by the system.
